(19) United States
(12) Patent Application Publication
(10) Pub. No.: US 2026/0342266 A1
(43) Pub. Date: Oct. 29, 2026

(54) MOTOR CONTROLLER

(71) Applicant: Global Mixed-mode Technology Inc., Hsin-Chu (TW)

(72) Inventor: Rong-Chin Lee, Pingtung County (TW)

(73) Assignee: Global Mixed-mode Technology Inc., Hsin-Chu (TW)

(21) Appl. No.: 19/186,658

(22) Filed: Apr. 23, 2025

(51) Int. Cl. H02P 27/08; H02P 27/14

(52) U.S. Cl. CPC H02P 27/085; H02P 27/14

(57) ABSTRACT

A motor controller comprises a switch circuit, a driving circuit, a pulse width modulation circuit, and a Hall sensor. The switch circuit is coupled to a motor for driving the motor. The driving circuit generates a plurality of control signals to control the switch circuit. The pulse width modulation circuit generates a pulse width modulation signal to the driving circuit. The Hall sensor generates a Hall signal to the pulse width modulation circuit. When the motor controller is operated in a start mode, the motor controller adopts a Hall sensor driving method. When the motor controller is operated in a normal mode, the motor controller adopts a sensorless driving method.

### BACKGROUND OF THE INVENTION

The present invention relates to a motor controller, and more particularly, to a motor controller which may be applied to a single-phase or three-phase motor. The motor controller may be a fan motor controller.

### DESCRIPTION OF THE PRIOR ART

Conventionally, there are two driving methods for driving a motor. The first driving method uses the Hall sensor for switching phases, so as to drive the motor. The second driving method does not use the Hall sensor to drive the motor. Due to the potential misalignment of the Hall sensor’s placement, it is difficult to obtain correct commutation angles under a normal mode. Besides, when using a sensorless driving method, the start mode generally results in a longer driving time and a lower success rate compared to systems equipped with Hall sensors.

Thus, a whole new technique is needed to solve the above issues.

### SUMMARY OF THE INVENTION

According to one embodiment of the present invention, a motor controller which may be applied to a single-phase or three-phase motor is provided. The motor controller may be a fan motor controller. The motor controller is configured to driving a motor. The motor controller comprises a switch circuit, a driving circuit, a pulse width modulation circuit, and a Hall sensor. The switch circuit is coupled to the motor for driving the motor. The switch circuit comprises a first terminal, a second terminal, and a third terminal, where the first terminal, the second terminal, and the third terminal respectively provides a first driving signal, a second driving signal, and a third driving signal for driving the motor. The driving circuit generates a plurality of control signals to control the switch circuit. The pulse width modulation circuit generates a pulse width modulation signal to the driving circuit. The pulse width modulation signal has a duty cycle. The Hall sensor generates a Hall signal to the pulse width modulation circuit.

In order to solve the prior-art issues, when the motor controller is operated in a start mode, the motor controller adopts a Hall sensor driving method. When the motor controller is operated in a normal mode, the motor controller adopts a sensorless driving method. More specifically, switching phases based on the Hall signal generated by the Hall sensor can make the motor start more smoothly. Furthermore, compared to sensorless driving methods, the driving time is shorter and the success rate is higher during the start process. When the motor controller completes the start mode and enters the normal mode, the motor controller may obtain the correct commutation point by detecting a zero point of a back electromotive force. At this time, the motor controller adopts the sensorless driving method.

According to one embodiment of the present invention, a driving process of the motor may have four steps as follows:
1. In order to start the motor smoothly, the duty cycle of the pulse width modulation signal starts from 0 and then increases gradually. When the motor controller is operated in the start mode and the duty cycle is less than an alignment duty cycle, the motor controller generates an alignment waveform based on the initial value of the Hall signal. The alignment waveform may be a part of an M-shaped waveform.
2. When the motor controller is operated in the start mode and the duty cycle is greater than the alignment duty cycle, the motor controller generates a series of pre-determined waveforms respectively to the first driving signal, the second driving signal, and the third driving signal during a first mandatory phase switching time, so as to enable the motor to get a first phase switching time point.
3. When the first phase switching time point appears, the motor controller generates a plurality of waveforms which correspond to the first phase switching time point respectively to the first driving signal, the second driving signal, and the third driving signal. Then the motor controller generates a series of pre-determined waveforms respectively to the first driving signal, the second driving signal, and the third driving signal during a second mandatory phase switching time, so as to enable the motor to get a second phase switching time point. The motor controller is operated in the start mode before the second phase switching time point. As mentioned before, when the motor controller is operated in the start mode, the motor controller adopts the Hall sensor driving method.
4. The motor controller is operated in the normal mode after the second phase switching time point. As mentioned before, when the motor controller is operated in the normal mode, the motor controller adopts the sensorless driving method. When the motor controller is operated in the normal mode and the motor controller starts a floating phase to detect a back electromotive force of the floating phase, the motor controller enables that the duty cycle is greater than or equal to a minimum value.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

The above-mentioned and other objects, features, and advantages of the present invention will become apparent with reference to the following descriptions and accompanying drawings, wherein:

FIG. 1 is a circuit diagram showing a motor controller according to one embodiment of the present invention;

FIG. 2 is a first timing chart according to one embodiment of the present invention; and

FIG. 3 is a second timing chart according to one embodiment of the present invention.

### DETAILED DESCRIPTION

Preferred embodiments according to the present invention will be described in detail with reference to the drawings.

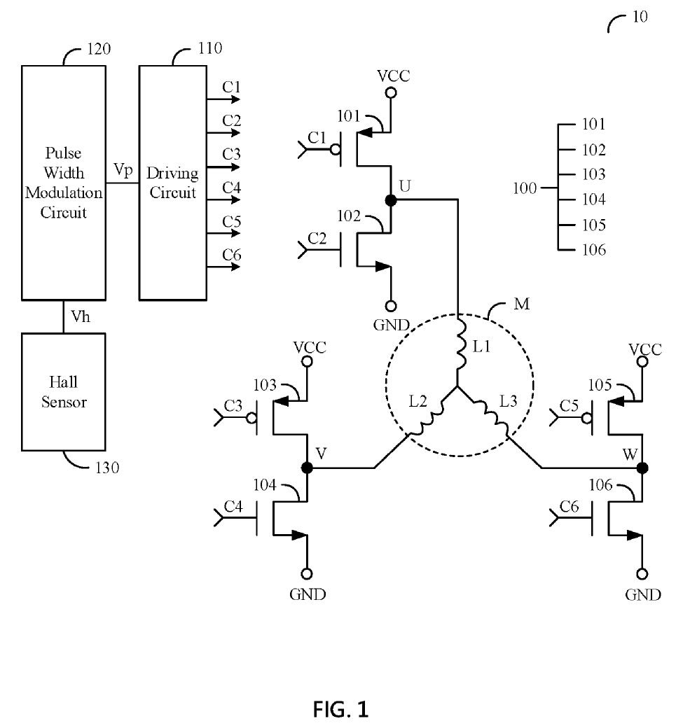

FIG. 1 is a circuit diagram showing a motor controller 10 according to one embodiment of the present invention. The motor controller 10 is used for driving a motor M, where the motor M has a first coil L1, a second coil L2, and a third coil L3. In other words, the motor M may be a three-phase motor, but the present invention is not limited thereto. The motor controller 10 comprises a switch circuit 100, a driving circuit 110, a pulse width modulation circuit 120, and a Hall sensor 130. The switch circuit 100 includes a first transistor 101, a second transistor 102, a third transistor 103, a fourth transistor 104, a fifth transistor 105, a sixth transistor 106, a first terminal U, a second terminal V, a third terminal W, a fourth terminal VCC, and a fifth terminal GND, where the switch circuit 100 is coupled to the motor M for driving the motor M. The first terminal U, the second terminal V, and the third terminal W respectively provides a first driving signal Su, a second driving signal Sv, and the third driving signal Sw for driving the motor M. The first transistor 101 is coupled to the fourth terminal VCC and the first terminal U while the second transistor 102 is coupled to the first terminal U and the fifth terminal GND. The third transistor 103 is coupled to the fourth terminal VCC and the second terminal V while the fourth transistor 104 is coupled to the second terminal V and the fifth terminal GND. The fifth transistor 105 is coupled to the fourth terminal VCC and the third terminal W while the sixth transistor 106 is coupled to the third terminal W and the fifth terminal GND. Each of the first transistor 101, the third transistor 103, and the fifth transistor 105 may be a p-type MOSFET. Each of the second transistor 102, the fourth transistor 104, and the sixth transistor 106 may be an n-type MOSFET.

One terminal of the first coil L1 is coupled to the first terminal U. One terminal of the second coil L2 is coupled to the second terminal V. One terminal of the third coil L3 is coupled to the third terminal W. Furthermore, another terminal of the first coil L1 is coupled to another terminal of the second coil L2 and another terminal of the third coil L3. That is to say, the first coil L1, the second coil L2, and the third coil L3 form a Y-shaped configuration. The driving circuit 110 generates a first control signal C1, a second control signal C2, a third control signal C3, a fourth control signal C4, a fifth control signal C5, and a sixth control signal C6 for respectively controlling the ON/OFF states of the first transistor 101, the second transistor 102, the third transistor 103, the fourth transistor 104, the fifth transistor 105, and the sixth transistor 106. The pulse width modulation circuit 120 generates a pulse width modulation signal Vp to the driving circuit 110, where the pulse width modulation signal Vp may be used for adjusting the speed of the motor M. The pulse width modulation signal Vp has a duty cycle. The Hall sensor 130 is coupled to the pulse width modulation circuit 120, so as to detect a magnetic pole position of the motor M and generate a Hall signal Vh to the pulse width modulation circuit 120 for driving the motor M. Since people of ordinary skill in the technology field should realize the method to drive the motor M, the detailed description is omitted.

In order to solve the prior-art issues, when the motor controller 10 is operated in a start mode, the motor controller 10 adopts a Hall sensor driving method. When the motor controller 10 is operated in a normal mode, the motor controller 10 adopts a sensorless driving method. More specifically, switching phases based on the Hall signal Vh generated by the Hall sensor 130 can make the motor M start more smoothly. Furthermore, compared to sensorless driving methods, the driving time is shorter and the success rate is higher during the start process. When the motor controller 10 completes the start mode and enters the normal mode, the motor controller 10 may obtain the correct commutation point by detecting a zero point of a back electromotive force. At this time, the motor controller 10 adopts the sensorless driving method.

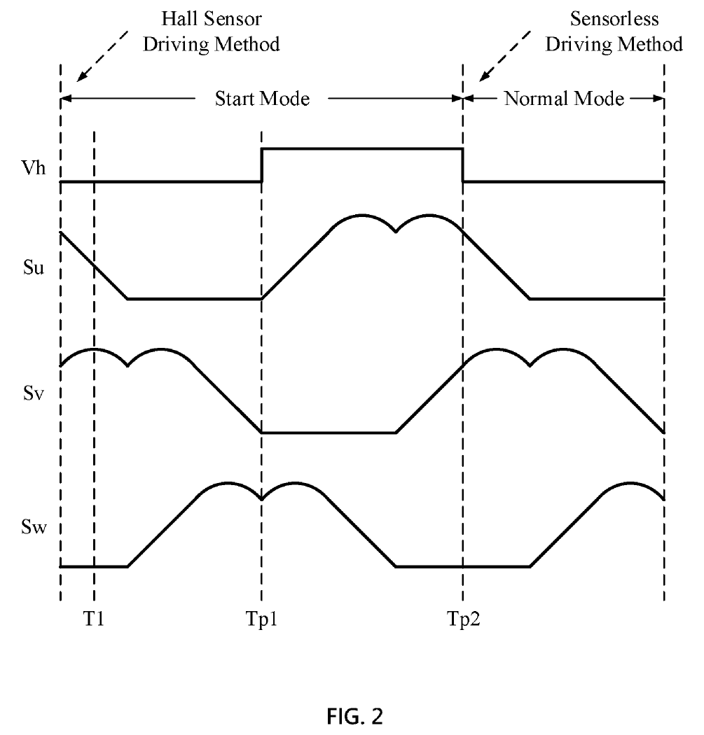

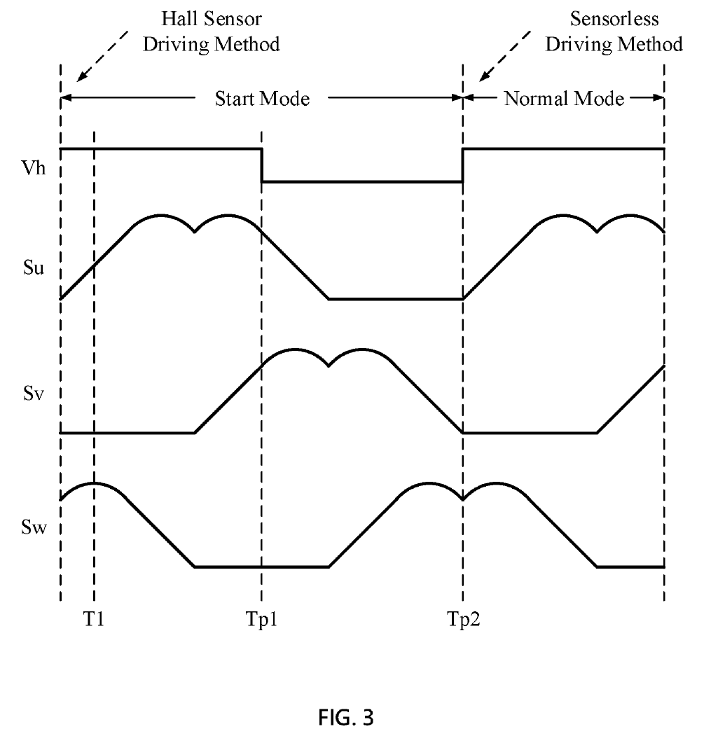

According to one embodiment of the present invention, a driving process of the motor M may have four steps as follows:
1. In order to start the motor M smoothly, the duty cycle of the pulse width modulation signal Vp starts from 0 and then increases gradually. When the duty cycle is less than an alignment duty cycle, the motor controller 10 generates different alignment waveforms based on the initial value of the Hall signal Vh. FIG. 2 is a first timing chart according to one embodiment of the present invention. The first timing chart shows the waveform of the first driving signal Su, the waveform of the second driving signal Sv, and the waveform of the third driving signal Sw generated by the motor controller 10 when the initial value of the Hall signal Vh is at a low level. The first time point T1 is the time point when the duty cycle is equal to the alignment duty cycle. FIG. 3 is a second timing chart according to one embodiment of the present invention. The second timing chart shows the waveform of the first driving signal Su, the waveform of the second driving signal Sv, and the waveform of the third driving signal Sw generated by the motor controller 10 when the initial value of the Hall signal Vh is at a high level. As shown in FIGS. 2 and 3 , the alignment waveform may be a part of an M-shaped waveform.
2. When the duty cycle is greater than the alignment duty cycle, the motor controller 10 generates a series of pre-determined waveforms respectively to the first driving signal Su, the second driving signal Sv, and the third driving signal Sw during a first mandatory phase switching time, so as to enable the motor M to get a first phase switching time point Tp1, where the first phase switching time point Tp1 is the time point when the first level variation of the Hall signal Vh occurs. The first phase switching time point Tp1 is greater than the first time point T1. As shown in FIGS. 2 and 3 , the pre-determined waveform may be a part of the M-shaped waveform.
3. When the first phase switching time point Tp1 appears, the motor controller 10 generates a plurality of waveforms which correspond to the first phase switching time point Tp1, respectively to the first driving signal Su, the second driving signal Sv, and the third driving signal Sw. Then the motor controller 10 generates a series of pre-determined waveforms respectively to the first driving signal Su, the second driving signal Sv, and the third driving signal Sw during a second mandatory phase switching time, so as to enable the three-phase motor M to get a second phase switching time point Tp2, where the second phase switching time point Tp2 is the time point when the second level variation of the Hall signal Vh occurs. The second phase switching time point Tp2 is greater than the first phase switching time point Tp1. As shown in FIGS. 2 and 3 , the pre-determined waveform may be a part of the M-shaped waveform. The motor controller 10 is operated in the start mode before the second phase switching time point Tp2. As mentioned before, when the motor controller 10 is operated in the start mode, the motor controller 10 adopts the Hall sensor driving method.
4. The motor controller 10 is operated in the normal mode after the second phase switching time point Tp2. As mentioned before, when the motor controller 10 is operated in the normal mode, the motor controller 10 adopts the sensorless driving method. When the motor controller 10 starts a floating phase to detect the back electromotive force of the floating phase, the motor controller 10 limits the duty cycle of the pulse width modulation signal Vp, such that the duty cycle is greater than or equal to a minimum value for avoiding that an ON time interval of the pulse width modulation signal Vp is too small. Thus, when the motor controller 10 detects the back electromotive force of the floating phase during the ON time interval, it results that the detection becomes easy and the success rate of the detection is increased. Based on different applications, the minimum value may be set to be equal to 10%, 20%, or the other suitable value.

The motor controller 10 of the present invention may be applied to a single-phase or three-phase motor. Moreover, the motor controller 10 may be a fan motor controller.

While the present invention has been described by the preferred embodiment, it is to be understood that the invention is not limited to the disclosed embodiment. On the contrary, it is intended to cover various modifications. Therefore, the scope of the appended claims should be accorded the broadest interpretation so as to encompass all such modifications.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A motor controller configured to drive a motor, the motor controller comprising:
a switch circuit, coupled to the motor for driving the motor;
a driving circuit, configured to generate a plurality of control signals to control the switch circuit;
a pulse width modulation circuit, configured to generate a pulse width modulation signal to the driving circuit; and
a Hall sensor, configured to generate a Hall signal to the pulse width modulation circuit, wherein when the motor controller is operated in a start mode, the motor controller adopts a Hall sensor driving method, and when the motor controller is operated in a normal mode, the motor controller adopts a sensorless driving method.

2. The motor controller of claim 1, wherein the pulse width modulation signal has a duty cycle, and when the motor controller is operated in the start mode and the duty cycle is less than an alignment duty cycle, the motor controller generates an alignment waveform based on an initial value of the Hall signal.

3. The motor controller of claim 2, wherein the alignment waveform is a part of an M-shaped waveform.

4. The motor controller of claim 1, wherein the switch circuit further comprises:
a first transistor, coupled to a fourth terminal and a first terminal;
a second transistor, coupled to a fifth terminal and the first terminal;
a third transistor, coupled to the fourth terminal and a second terminal;
a fourth transistor, coupled to the fifth terminal and the second terminal;
a fifth transistor, coupled to the fourth terminal and a third terminal; and
a sixth transistor, coupled to the fifth terminal and the third terminal.

5. The motor controller of claim 1, wherein the pulse width modulation signal has a duty cycle, and when the motor controller is operated in the start mode and the duty cycle is greater than an alignment duty cycle, the motor controller generates a series of pre-determined waveforms respectively to a first driving signal, a second driving signal, and a third driving signal during a first mandatory phase switching time, so as to enable the motor to get a first phase switching time point.

6. The motor controller of claim 5, wherein the motor controller generates a series of pre-determined waveforms respectively to the first driving signal, the second driving signal, and the third driving signal during a second mandatory phase switching time, so as to enable the three-phase motor to get a second phase switching time point, and the second phase switching time point is greater than the first phase switching time point.

7. The motor controller of claim 6, wherein the motor controller is operated in the start mode before the second phase switching time point.

8. The motor controller of claim 6, wherein the motor controller is operated in the normal mode after the second phase switching time point.

9. The motor controller of claim 1, wherein the pulse width modulation signal has a duty cycle, and when the motor controller is operated in the normal mode and the motor controller starts a floating phase to detect a back electromotive force of the floating phase, the motor controller enables that the duty cycle is greater than or equal to a minimum value.

10. The motor controller of claim 1, wherein the motor controller is applied to a single-phase motor.

11. The motor controller of claim 1, wherein the motor controller is applied to a three-phase motor.

12. The motor controller of claim 1, wherein the motor controller is a fan motor controller.
